(19) United States
(12) Patent Application Publication
(10) Pub. No.: US 2013/0299668 A1
(43) Pub. Date: Nov. 14, 2013

(54) ELEMENT FOR ENGAGING A PORTABLE MEDIA PLAYER

(71) Applicant: Jørgen Daucke Von Barner, Struer (DK)

(72) Inventor: Jørgen Daucke Von Barner, Struer (DK)

(73) Assignee: BANG & OLUFSEN A/S, Struer (DK)

(21) Appl. No.: 13/988,167

(22) PCT Filed: Nov. 25, 2011
(86) PCT No.: PCT/EP2011/071045

§ 371 Date: Jun. 24, 2013

(30) Foreign Application Priority Data
Dec. 1, 2010 (DK) PA 2010 01088
Jan. 31, 2011 (DK) PA 2011 00056

(51) Int. Cl. F16M 13/00

(52) U.S. Cl. CPC F16M 13/00
USPC 248/542; 248/558

(57) ABSTRACT

An element for engaging a portable media player and an assembly of an element and a media player, where the element is adapted to engage the media player and facilitate orientating the media player in each of four different orientations: upright portrait mode, upright landscape mode, horizontal portrait mode and nearly horizontal landscape mode. In addition, the element is adapted to determine the orientation of the media player and operate built-in speakers accordingly. Also, the media player may be operated to initiate or shift to software or applications predetermined for each individual orientation.

The present invention relates to an element for engaging a portable media player and in particular an element which has a plurality of rest positions in which the portable media player may be viewed in the landscape mode and the portrait mode both with the display almost vertical and with the display almost horizontal.

Elements for providing different viewing positions for media players or media may be seen in e.g. U.S. Pat. No. 5,566,098.

A first aspect of the invention relates to an element for engaging a portable media player, the element comprising:
a first surface, the element comprising, at or in the first surface, means for engaging the media player, the media player having a display which may be directed in a portrait mode and a landscape mode,
a second, a third, a fourth, and a fifth surface parts of the element,
a corner or predetermined outer part of the element from which the second, third, fourth and fifth surface parts extend, so that:
   when the element is supported on the second surface part, the first surface is at a position in which the media player may be supported in the portrait mode and at an essentially horizontal position,
   when the element is supported on the third surface part, the first surface is at a position in which the media player may be supported in the landscape mode and at an essentially horizontal position,
   when the element is supported on the fourth surface part, the first surface is at a position in which the media player may be supported in the portrait mode and at an essentially upright position, and so that
   when the element is supported on the fifth surface part, the first surface is at a position in which the media player may be supported in the landscape mode and at an essentially upright position.

In this connection, a portable media player is any type of media player preferably comprising a power source, such as a battery, fuel cell, solar cell or the like. Usually, a media player comprises a user interface, such as a keyboard, rotatable element, buttons, touch pad of the like. Also, the preferred media player has a display which, when the media player is engaged by the element, is visible from the outside of the element.

Naturally, any type of media may be provided by the media player, such as music, songs, video, TV, images, pictures, or the like. In fact, as will be illustrated further below, music or other audio signals may be provided by the media player but actually be output by the element. Additionally or alternatively, the media player may be used for other purposes, such as text editing, surfing on the Internet, or the like.

Typical media players are MP3 players, MP4 players, cell phones, tablet PCs, iPad®, iPod®, iPhone®, iPod Touch®, or the like.

The engagement means may provide any form of engagement of the media player. A simple manner of engaging the player is to detachably fix it in a press fit, such as when the engagement means comprise resilient means for engaging the media player and detachably fixing the media player to the element.

The engagement means may also comprise a plug-and-socket arrangement, as will be described further below, which may be used for engaging the media player but also for interchanging power and/or signals between the element and media player.

The engagement preferably is detachable. The engagement may be facilitated using an adhesive, nut-and-bolt engagement, press fitting, plug-and-socket engagement, or the like. Alternatively, the media player may be provided in a pocket or slot, or the like, in the element or attached thereto.

Preferably, the surface parts are at least relatively flat, so that the media player may be supported thereon without excessive movement/rocking thereof when e.g. being operated. Naturally, rounded corners and sides/edges may be provided, for example.

The first surface may be an outer surface of the element or a surface adapted to support eg. a back side of the media player when engaged, if the media player is of at least substantially even thickness over its surface (over the display surface, for example).

In the present context, the portrait mode and the landscape mode are rotations of an oblong display of the media player when engaged by the engaging means. The landscape mode is a mode in which the longest sides of the display are horizontal while displaying an image (movie, web application, word processor) adapted for viewing by a person standing up, and the portrait mode is one in which the shortest sides thereof are horizontal. Typically, the display will be rectangular.

In this respect, “essentially upright” is an angle to horizontal which is 45 degrees or more, and “essentially horizontal” is a position in which the angle to horizontal is 45 degrees or less.

The corner or predetermined outer part of the element may have any shape and be positioned anywhere on the element. When the second, third, fourth and fifth surface parts extend from the corner/part, the second, third, fourth and fifth surface parts extend to at least the vicinity thereof, so that rotation around that corner/part may bring the element from being supported by one of the surface parts to being supported by another of the surface parts.

Another advantage is that no matter which of the second, third, fourth and fifth surface part the element rests on, the corner/part will be positioned close to or at the surface on which the element rests. Thus, the weight or centre of gravity of the element may be positioned at or close to this corner/part.

Preferably:
the first surface defines a first plane, a first and a second predetermined direction being defined in the first plane,
the second surface defines a second plane, the second plane intersecting the first plane at a line parallel with the first direction and being at an angle of 1-45 degrees to the first plane,
the third surface defines a third plane, the third plane intersecting the first plane at a line parallel with the second direction and being at an angle of 1-45 degrees to the first plane,
the fourth surface defines a fourth plane, the fourth plane intersecting the first plane at a line parallel with the first direction and being at an angle of 45-90 degrees to the first plane,
the fifth surface defines a fifth plane, the fifth plane intersecting the first plane at a line parallel with the second direction and being at an angle of 45-90 degrees to the first plane.

The invention may also be seen as an element for engaging a portable media player, the element comprising:
a first surface defining a first plane, the element comprising, at or in the first surface, means for engaging the media player, a first and a second predetermined directions being defined in the first plane,
a second surface defining a second plane, the second plane intersecting the first plane at a line parallel with the first direction and being at an angle of 1-45 degrees to the first plane,
a third surface defining a third plane, the third plane intersecting the first plane at a line parallel with the second direction and being at an angle of 1-45 degrees to the first plane,
a fourth surface defining a fourth plane, the fourth plane intersecting the first plane at a line parallel with the first direction and being at an angle of 45-90 degrees to the first plane,
a fifth surface defining a fifth plane, the fifth plane intersecting the first plane at a line parallel with the second direction and being at an angle of 45-90 degrees to the first plane.

In this context, preferably the first, second, third, fourth and/or fifth planes is/are straight plane(s), and preferably at least the second, third, fourth and fifth surfaces are at least substantially plane/straight/flat so as to provide a stable support when the element rests with the particular surface against a horizontal, plane/flat surface.

The first surface defines a first plane. Usually, the first surface will be relatively flat, whereby the first plane is easily determined. It may be preferred to provide the first surface with more rounded outer parts. In this situation, the first plane may be estimated rather simply. Also, the first surface may have a surface part adapted to engage a part of the media player. In that situation, this surface part most often is desired plane, as the back part of a media player usually is desired relatively flat for it to be stable when positioned on a plane surface. The first plane may alternatively be defined by a surface of the media player display, when the media player is engaged by the element.

The predetermined directions will usually be the main directions of a display. These directions typically will be those along which text may be displayed on the display. Usually, displays are rectangular, and the directions in that situation may be along the sides of the display.

Most often, the two directions are perpendicular to each other.

The second surface defines the second plane. As is the situation with the first surface/plane, and the third to fifth surfaces/planes, the individual plane may be determined by a part of the respective surface, if eg. a more straight/plane part of the surface exists. Often, the plane may be determined as that touching a flat, horizontal surface, when the element rests on the pertaining surface on the flat, horizontal surface.

When the second and third planes are 1-45 degrees to the first plane, the first plane will be 1-45 degrees from horizontal, when the element rests on the second or third planes. At the same time, as the second/third planes intersect the first plane along the first and second directions, respectively, the first or second direction will be horizontal, when the element rests on the second or third surface and on a flat, horizontal surface.

Thus, when a media player is engaged and text is provided along the first direction, the text will be provided along a horizontal direction, when the element rests on the second surface and on a flat, horizontal surface, while the first surface has an angle of 1-45 degrees to horizontal. Thus, a relatively flat displaying of the media player may be provided—both along the first and the second directions.

Alternatively, the fourth and fifth surfaces and planes have an angle of 45-90 degrees to the first plane, but these planes also intersect the first plane along the first and second directions, respectively. Then, the first surface and therefore a display of the media player may be provided in a more upright position (45-90 degrees to horizontal) when resting on the fourth/fifth surfaces on a horizontal surface, while still allowing viewing of the display along the first and second directions.

Naturally, in this context, a small angular variation is allowed due to e.g. misplacement or erroneous engagement between the media player and the element. Thus, even if the element is supported on a perfectly horizontal surface, the first and second directions or the landscape mode and the portrait mode may vary from a perfect horizontal alignment by up to 10 degrees, for example.

It is clear that a direction or e.g. a line of a text on the display may be horizontal even if the display is tilted in relation to a vertical direction. For example, a line of text on a word processor used on a laptop supported on a horizontal surface will be horizontal irrespective of the angle of the laptop display in relation to vertical.

Preferably:
a centre of mass of the element, when projected on to the second plane or surface part, being positioned within the second surface (part),
the centre of mass of the element, when projected on to the third plane or surface part, being positioned within the third surface (part),
the centre of mass of the element, when projected on to the fourth plane or surface part, being positioned within the fourth surface (part), and
the centre of mass of the element, when projected on to the fifth plane or surface part, being positioned within the fifth surface (part).

Naturally, the centre of mass of the element may be determined in a number of manners. When the centre of mass is provided over (horizontally) or within a surface on which the element rests, the element will be resting and immobilized. In this context, a surface may be defined by areas or even points, as long as at least three points of contact exist within which the centre of mass is positioned when projected onto the surface supporting the element and engaging the points of contact.

Thus, when the centre of mass is positioned “within” a surface, the surface need not be continuous or unbroken. It suffices that three points of contact exist between e.g. the surface and a plane, horizontal surface, where the centre of mass is positioned within a geometrical figure having the all points of contact as corners connected by straight lines.

Preferably, the angle between the first and second and/or third planes, or the angle of the essentially horizontal mode is below 30 degrees, such as below 20 degrees, such as 10-20 degrees.

Preferably, the angle between the first and fourth and/or fifth planes or the angle of the essentially upright mode is above 70 degrees, such as above 80 degrees, such as 80-90 degrees.

In one embodiment, the engaging means comprise a depression adapted to receive at least part of the media player in a manner, so that a first major direction of a display of the media player is directed along the first direction. Then, a second major direction of the display may be directed along the second direction.

In this context, a major direction may be a straight side of the display or a direction along which text is usually provided on the display. Usual displays are rectangular, where the two major directions then may be parallel to the parallel sides of the rectangle.

Naturally, the depression may have dimensions so that the media player may be fully received therein or only partly therein, so as to extend partly out of the depression. In the latter situation, removal of the media player may be obtained by directly engaging the media player, whereas in the first situation, an element may be provided which, when engaged, pushes the media player out of the depression.

In that or another embodiment, the engaging means comprises conductors adapted to provide power to the media player when engaged by the engaging means. In this manner, a charging, etc. may take place. In addition, these conductors may be used for providing the engagement between the element and media player as well as transport signals to/from the media player.

Naturally, the conductors may be a part of a plug-and-socket arrangement also providing a degree of engagement between the element and media player. In another embodiment, the conductors may be conducting surface parts of the element which are adapted to abut/contact corresponding surface parts of a media player when engaging.

In one embodiment, the engaging means are adapted to engage the media player so that a display of the media player is at least substantially parallel with the first plane/surface part. In this manner, the display of the media player will have the above angles to horizontal, when the element is brought to rest on the second-fifth surfaces.

In one embodiment, the element further comprises a sensing device adapted to determine which of the second, third, fourth or fifth sides is horizontal, or is the closest to horizontal, and outputting a corresponding signal. Naturally, any surface or plane will have a determinable angle to horizontal, and the output may be an indication of the surface which is the most horizontal or an angle of each surface/plane to horizontal, for example. This is similar to the operation of smart phones today which are able to determine a rotation or direction thereof and rotate the image provided on the display accordingly.

In fact, the media player may be adapted to receive such information and start or run an application determined by the surface or angle determined. Thus, if the display is relatively upright and a longest side is horizontal, a video player may be provided, whereas an internet explorer may be started, if the display is upright and in the portrait mode. The more horizontal positions may be used especially for word processing (usually portrait mode) and the like where the display is to be operated or engaged with, such as if the display is a touch pad, as this is easier, if the touch pad is more or less horizontal.

In that embodiment, or an embodiment in which the media player has a sensing means, the element may further comprise at least 3 loudspeakers adapted to output sound from or through the first surface, at least two of the loudspeakers being positioned along the first direction, or along the side horizontal when in portrait mode, and at least two of the loudspeakers being positioned along the second direction, or along the side horizontal when in landscape mode the element comprising a processor receiving the corresponding signal and operating the loudspeakers accordingly. In this respect, the speakers are provided “along” the direction when a line through centres of the speakers is at least substantially along the direction in question.

In this situation, the speakers arranged along the direction of the first and second directions which is the most horizontal may be operated while others of the speakers may be silenced, so that stereo audio may be output. The speakers may be provided at positions outside the engaging means so as to output sound from a position outside the media player when engaged. When the sets of speakers are provided along the first and second directions, a set of speakers is always more or less horizontal, when the element rests on a horizontal surface on one of the second-fifth surfaces.

In this situation, the processor may be adapted to receive a first signal from the engaging means, such as from the media player when engaging, and output a second signal to the loudspeakers. Usually, the second signal will relate to the first signal but may be filtered, amplified or the like. The media player may output sound relating to a video provided or sound played, and the element may receive the sound signal and adapt it to certain circumstances, such as the type of speakers provided, positions thereof, features thereof (tweeter, subwoofer), and user settings, such as volume, filtering (loudness or not, more or less bass, mono, stereo, multichannel, etc)

A second aspect of the invention relates to an assembly comprising an element according to the first aspect and a media player engaged by the engaging means.

Naturally, all the above features of the element are equally relevant in this aspect. The engagement may, though, be permanent.

In one situation, at least part of the media player is received in a depression of the engaging means in a manner, so that a first major direction of a display of the media player is directed along the first direction. Naturally, a second major direction of the display may be directed along the second direction. A major direction may be one in which text is displayed in e.g. a text editor.

Also, the engaging means preferably comprises conductors adapted to provide power to the media player. The media player and element may comprise a plug-and-socket assembly for providing power. This assembly may also provide at least part of the engagement between the media player and element.

Alternatively, the element and media player may comprise conducting surfaces adapted to abut, when the media player is engaged by the element.

It is preferred that the engaging means are adapted to engage the media player so that a display of the media player is at least substantially parallel with the first plane.

In a preferred embodiment, the assembly further comprises a sensing device adapted to determine which of the second, third, fourth or fifth sides is, exactly or the most, horizontal and outputting a corresponding signal. This sensing device may be provided in the element and/or the media player.

In that embodiment, the element preferably further comprises at least 3 loudspeakers adapted to output sound from or through the first surface, at least two of the loudspeakers being positioned along the first direction, or along the side horizontal when in landscape mode, and at least two of the loudspeakers being positioned along the second direction, or along the side horizontal when in portrait mode, the element comprising a processor receiving the corresponding signal and operating the loudspeakers accordingly.

As mentioned above, in addition or alternatively, the media player may be operated to initiate or shift to an application pre-selected for the new orientation of the media player, as determined by the sensing device.

Then, the processor preferably is adapted to receive a first signal from the media player and output a second signal to the loudspeakers. This is described above.

A third aspect of the invention relates to a method of operating an assembly according to the second aspect, the method comprising the steps of:
1. positioning the assembly so that one of the second and fourth sides is horizontal and providing on a display of the media player an image rotated in a first manner in relation to the media player,
2. subsequently positioning the assembly so that one of the third or fifth sides is horizontal and providing on the display of the media player the image rotated in a second manner in relation to the media player.

Usually, the rotation of the image provided on the display has two main directions. In a text editor and a browser, eg, but also when providing video or the like, a horizontal and a vertical direction is defined. These directions may be rotated on the display, when the display is rotated in relation to horizontal in order for the user (assumed to keep his/her head vertical and eyes horizontal) to still be able to understand what is provided on the display.

Rotating the assembly into one of the positions described will make the media player rotate the image so that a predetermined horizontal line in the image is also more horizontal than the direction perpendicular thereto.

A final aspect of the invention relates to a method of operating the assembly according to the second aspect, the method comprising the steps of:
1. repositioning the assembly from a first position in which one of the second, third, fourth and fifth sides is horizontal into a second position in which another one of the second, third, fourth and fifth sides is horizontal and
2. operating the media player to run an application determined by which of the second, third, fourth and fifth sides is the other one of the second, third, fourth and fifth sides.

The application run or shifted to may be pre-selected and based on the viewing or operability of the media player when in the new position. Some positions and rotations of a media player are more suitable for viewing video, others for surfing on the Internet, others again are more suitable for word processing where the user engages the media player, such as if its display is a touch pad, more extensively.

In the last two aspects, and as is mentioned further above, the element of the assembly preferably further comprises at least 3 loudspeakers adapted to output sound from or through the first surface, at least two of the loudspeakers being positioned along the first direction and at least two of the loudspeakers being positioned along the second direction, and wherein:
step 1. comprises operating the at least two of the loudspeakers being positioned along the first direction, and
step 2. comprises operating the at least two of the loudspeakers being positioned along the second direction.

In the following, preferred embodiments of the invention are described with reference to the drawing, wherein:

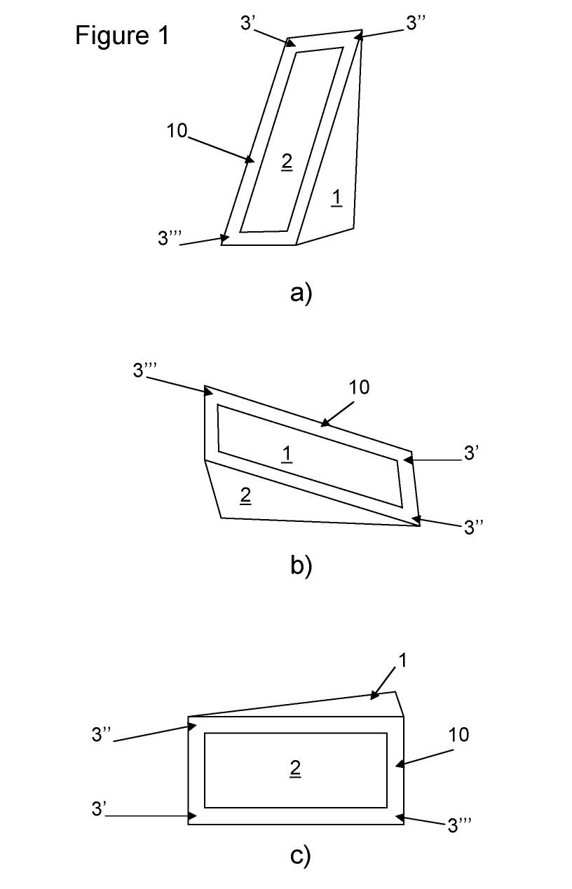

FIG. 1 illustrates how the element or platform may be placed in different positions,

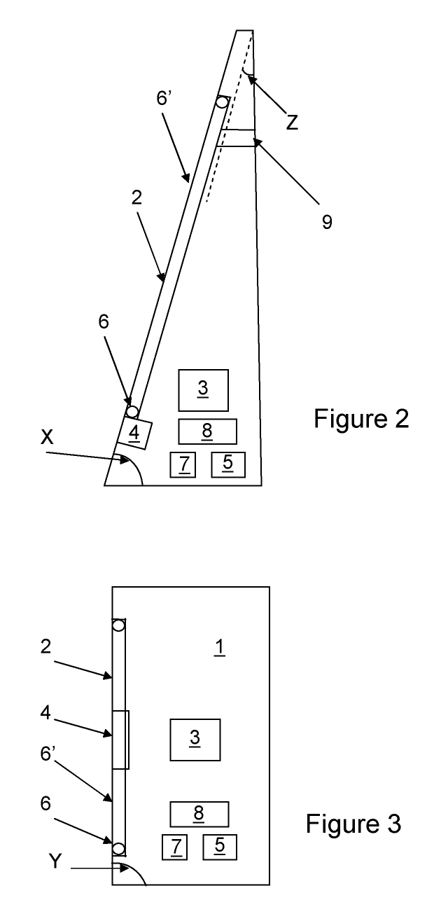

FIG. 2 illustrates a cross sectional view of the platform being in a portrait orientation,

FIG. 3 illustrates a cross sectional view of the platform being in a landscape orientation,

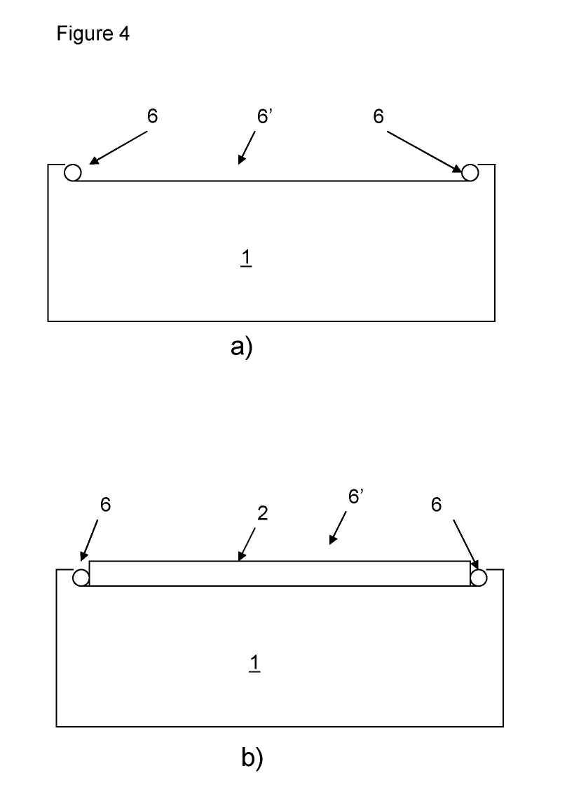

FIG. 4 illustrates a cross sectional view of the platform being in a horizontal orientation and

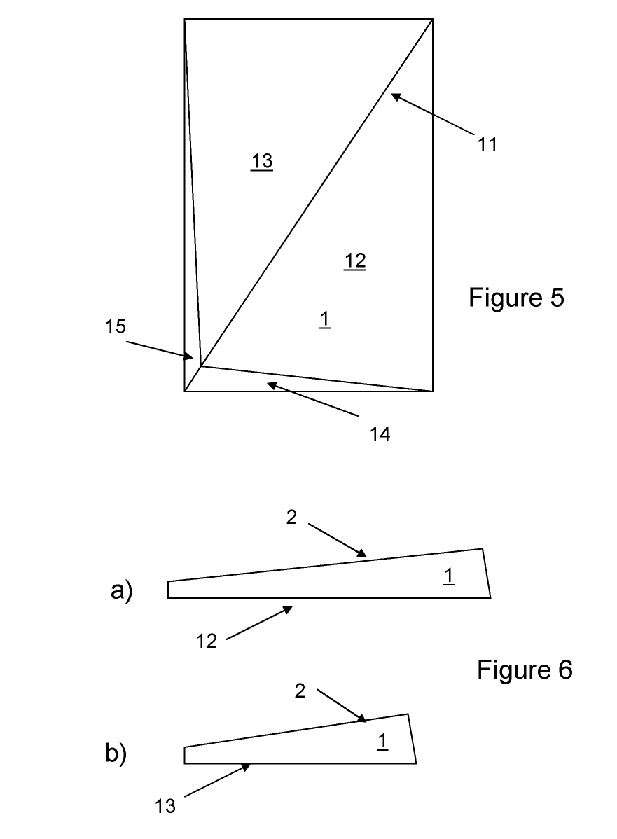

FIGS. 5 and 6 illustrate alternative positions in the horizontal orientation.

Summary of the features of the preferred embodiment are:
Optimal placement with view modes according to user wishes:
   portrait mode to support standard browsing/navigating/viewing via the display screen/touch screen;
   landscape mode, in which the display screen acts like a TV screen, primary for viewing;
   horizontal mode, in which the display screen supports navigating/viewing/editing/writing via the display screen/touch screen,
optimal sound via the built-in speakers, where reconfiguring the speakers allows for an optimal L/R providing to the loudspeakers which actually are in the left/right position relative to the user in front of the screen,
automatic selection of the mode of operation of the device and content displayed on the screen according to the actual orientation of the device; thus this implies that specific individual application programs may be enabled and be active in the docked device, according to the orientation thereof. E.g. a web browser application is activated when the device is orientated horizontally, a TV application is activated when the device is orientated in “landscape mode” and a book reader is activated when the device is in oriented to “portrait mode”. The user may define these specific application modes as predefined defaults in the control system and
a simple and effective fixture of the portable device when this is docked via the connector into the platform. The connector establishes the electrical connection to the portable device as well as a mechanical connection.

FIG. 1 illustrates how the device platform (1) may be positioned in different modes of orientation: a) the upright position in which the media player or display (2) is in portrait mode, i.e. vertically aligned; b) the “flat” position in which the display (2) is in horizontal mode; and c) the landscape mode where the display (2) is upright but horizontally aligned.

One or more loudspeakers (3′), (3″), (3′″) may be included in the frame (10) of the platform around the display (2). According to product requirements, the one or more speakers may be located on the front of the platform or in any of the sides of the platform, as appropriate to size and volume of the specific speaker unit.

It is seen that in any of the orientations, two of the speakers (3′), (3″) and (3′″) are positioned to the right and to the left of the display (2), whereby these may be used for generating stereo sound correctly positioned in relation to the display (2). It is also seen that one of the speakers normally is silenced (speaker (3′″) in FIG. 1a, so as to have the remaining speakers positioned symmetrically and horizontally around the display (2).

FIGS. 2 and 3 illustrate how the geometry of the platform allows optional placement and orientation of the device (1).

FIG. 2 illustrates the device (1) in an upright position. The surface in which the display (2) is mounted is tilted in an angle X close to 90°; in the preferred embodiment the angle is close to 85°, and the angle Z is approximately 15°.

The display of the media player (2) can be a dedicated or a standard display system based on LCD, LED, Plasma, OLED and the like. This is not important to the invention.

Alternatively, a multimedia device e.g. an iPad® (2) may be docked in a recess 6′ in the platform. The multimedia device is connected electrically and mechanically via a connector (4). A simple means in terms of a rubber O-ring (6) is used as the fixture to keep the device (2) in a stable position when docked. The multimedia device (2) may be released by pushing with a finger onto the backside of the device, through a small opening (9) in the back surface of the platform. Alternatively, an element, such as a lever, may be provided which forces the device (2) out of engagement with the O-ring when engaged by a user.

To give stability, the centre point of gravity of the platform device is preferably located at the bottom of the device; thus, a counterweight (3) is embedded into the platform at the lower half.

In the preferred embodiment, a loudspeaker partly or fully constitutes the counterweight (3). Alternatively, moveable counterweights may be adapted to give stability, a counterweight system based on one or more moveable objects and/or one or more liquid containers may be applied.

Standard means are preferably integrated into the platform (1):
Power supply means (7) to support all electrical objects placed in the platform (1) as well as the device (2).
Sound filtering—and amplifier means (8) for supporting all sound provider means placed in the platform (1).
Control means (5) supporting man-machine-interaction and wireless data transmission and remote control in or of the platform (1).
Control means (5) for detecting the orientation of the platform (1), the orientation e.g. being portrait/landscape and/or vertical/horizontal, and for adjusting the information content presented on the display accordingly. Default application programs may be defined to be active in each of the specific orientations.
Control means (5) for detecting the orientation of the platform (1), the modes being portrait/landscape and vertical/horizontal, and for providing the sound on the one or more loudspeakers according to the audio signal Left/Right channel accordingly.

FIG. 3 illustrates the device (1) in a vertical/upright landscape mode position. The surface in which the display (2) is mounted is tilted in an angle Y close to 90°; in the preferred embodiment the angle is 85.4° in portrait mode and 81.9° in landscape mode.

In addition to the elements described above (3, 4, 5, 7, 8) the O-ring fixture (6) is illustrated.

FIG. 4 illustrates how a multimedia device (2) e.g. an iPad®, is docked into the platform (1) and how the O-ring (6) is used as a fixture.

FIG. 4 a) illustrates the platform (1) prior to docking, and FIG. 4 b) illustrates the platform (1) including the docked iPad (2).

FIGS. 5 and 6 illustrate the bottom of the device configured with two back surfaces (12, 13) connected along a common diagonal axis (11). This configuration enables the platform (1) to be in two alternative horizontal positions a) portrait position and b) landscape position, while the edges or side surfaces 14 and 15 allow the platform (1) to be positioned upright in both the portrait and landscape positions as illustrated in FIGS. 1a, 2 and 3.

Thus, in the right-most part and the upper-most part of FIG. 5, narrower edge surfaces (not illustrated) are provided, whereas the edge surfaces to the left (15) and at the bottom (14) are made triangular and deeper to provide a better support for the element 1.

Naturally, the same operation may be obtained without requiring the line 11 to be diagonal. This may in principle depend on the centre of gravity, as it is desired that the assembly may rest unaided on all of the surfaces 12, 13, 14 and 15 on a horizontal surface, such as a table.

More precisely, when the platform (1) rests on a horizontal surface and on surface 12, as is seen in FIG. 6a, the display (2) will be lying more or less flat on the surface (the angle of the surface of the display (2) to horizontal will be that between the display (2) surface and the surface 12), but with the right most edge in FIG. 5 horizontal. Thus, the display (2) will be in the landscape mode with the longest side horizontal. In this mode, the angle of surface 2 to horizontal preferably is 16.2°.

Alternatively, when the platform (1) rests on a horizontal surface and on surface 13, as is seen in FIG. 6b the display (2) will be lying more or less flat on the surface (the angle of the surface of the display (2) to horizontal will now be that between the display (2) surface and the surface 13), but with the upper most edge in FIG. 5 horizontal. Thus, the display (2) will be in the portrait mode with the smallest side horizontal. In this mode, the angle of surface 2 to horizontal preferably is 9.3°.

The angle between the surfaces 12 and 13 is preferably 71.4°.

The present invention discloses a platform as an apparatus offering a set of features and utilities applied to enhance the usability of portable media players.

It adds comfort in operation and controlling the multimedia device, and it enhances the quality of the picture—and sound information provided to the user.

The platform adapts to many different types of mobile devices.

1. An element for engaging a portable media player, the element comprising:
a first surface, the element comprising, at or in the first surface, means for engaging the media player, the media player having a display which may be directed in a portrait mode and a landscape mode,
a second, a third, a fourth, and a fifth surface parts of the element,
a corner or predetermined outer part of the element from which the second, third, fourth and fifth surface parts extend, so that:
when the element is supported on the second surface part, the first surface is at a position in which the media player may be supported in the portrait mode and at an essentially horizontal position,
when the element is supported on the third surface part, the first surface is at a position in which the media player may be supported in the landscape mode and at an essentially horizontal position,
when the element is supported on the fourth surface part, the first surface is at a position in which the media player may be supported in the portrait mode and at an essentially upright position, and so that
when the element is supported on the fifth surface part, the first surface is at a position in which the media player may be supported in the landscape mode and at an essentially upright position.

2. An element according to claim 1, wherein:
the first surface defines a first plane, a first and a second predetermined direction being defined in the first plane,
the second surface defines a second plane, the second plane intersecting the first plane at a line parallel with the first direction and being at an angle of 1-45 degrees to the first plane,
the third surface defines a third plane, the third plane intersecting the first plane at a line parallel with the second direction and being at an angle of 1-45 degrees to the first plane,
the fourth surface defines a fourth plane, the fourth plane intersecting the first plane at a line parallel with the first direction and being at an angle of 45-90 degrees to the first plane,
the fifth surface defines a fifth plane, the fifth plane intersecting the first plane at a line parallel with the second direction and being at an angle of 45-90 degrees to the first plane.

3. An element according to claim 1, wherein the engaging means comprise a depression adapted to receive at least part of the media player in a manner, so that a first major direction of a display of the media player is directed along the first direction.

4. An element according to claim 2, wherein:
a centre of mass of the element, when projected on to the second plane, being positioned within the second surface,
the centre of mass of the element, when projected on to the third plane, being positioned within the third surface,
the centre of mass of the element, when projected on to the fourth plane, being positioned within the fourth surface, and
the centre of mass of the element, when projected on to the fifth plane, being positioned within the fifth surface
5. An element according to claim 1, further comprising a sensing device adapted to determine which of the second, third, fourth or fifth sides is horizontal and outputting a corresponding signal.

6. An element according to claim 5, further comprising at least 3 loudspeakers adapted to output sound from or through the first surface, at least two of the loudspeakers being positioned along the first direction and at least two of the loudspeakers being positioned along the second direction, the element comprising a processor receiving the corresponding signal and operating the loudspeakers accordingly.

7. An element according to claim 6, wherein the processor is adapted to receive a first signal from the engaging means and output a second signal to the loudspeakers.

8. An assembly comprising an element according to claim 1 and a media player engaged by the engaging means.

9. An assembly according to claim 8, wherein at least part of the media player is received in a depression of the engaging means in a manner, so that a first major direction of a display of the media player is directed along the first direction.

10. An assembly according to claim 8, further comprising a sensing device adapted to determine which of the second, third, fourth or fifth sides is horizontal and outputting a corresponding signal.

11. An assembly according to claim 10, wherein the element further comprises at least 3 loudspeakers adapted to output sound from or through the first surface, at least two of the loudspeakers being positioned along the first direction and at least two of the loudspeakers being positioned along the second direction, the element comprising a processor receiving the corresponding signal and operating the loudspeakers accordingly.

12. An assembly according to claim 11, wherein the processor is adapted to receive a first signal from the media player and output a second signal to the loudspeakers.

13. A method of operating an assembly according to claim 8, the method comprising the steps of:
1. positioning the assembly so that one of the second and fourth sides is horizontal and providing on a display of the media player an image rotated in a first manner in relation to the media player,
2. subsequently positioning the assembly so that one of the third or fifth sides is horizontal and providing on the display of the media player the image rotated in a second manner in relation to the media player.

14. A method of operating an assembly according to claim 8, the method comprising the steps of:
1. repositioning the assembly from a first position in which one of the second, third, fourth and fifth sides is horizontal into a second position in which another one of the second, third, fourth and fifth sides is horizontal and
2. operating the media player to run an application determined by which of the second, third, fourth and fifth sides is the other one of the second, third, fourth and fifth sides.

15. A method according to claim 13, wherein the element of the assembly further comprises at least 3 loudspeakers adapted to output sound from or through the first surface, at least two of the loudspeakers being positioned along the first direction and at least two of the loudspeakers being positioned along the second direction, and wherein:
step 1. comprises operating the at least two of the loudspeakers being positioned along the first direction, and
step 2. comprises operating the at least two of the loudspeakers being positioned along the second direction.
